(19) United States
(12) Patent Application Publication
(10) Pub. No.: US 2024/0184444 A1
(43) Pub. Date: Jun. 6, 2024

(54) DATA PROCESSING METHOD AND ELECTRONIC DEVICE

(71) Applicant: Lenovo (Beijing) Limited, Beijing (CN)

(72) Inventor: Xiaoqing LIU, Beijing (CN)

(21) Appl. No.: 18/467,847

(22) Filed: Sep. 15, 2023

(30) Foreign Application Priority Data
Dec. 1, 2022 (CN) 202211537871.8

(51) Int. Cl. G06F 3/04886; G06F 1/16; G06F 21/84

(52) U.S. Cl. CPC G06F 3/04886; G06F 1/1616; G06F 21/84

(57) ABSTRACT

A data processing method including obtaining a first parameter, the first parameter characterizing a relative position of a first body of an electronic device and a second body of the electronic device, a deformation of a display screen of the electronic device being corresponding to the relative position of the first body and the second body; and determining a target output area based on the first parameter, the target output area displaying a target object, the target output area belongs to a display area of the display screen.

### CROSS-REFERENCES TO RELATED APPLICATION

This application claims priority to Chinese Patent Application No. 202211537871.8 filed on Dec. 1, 2022, the entire content of which is incorporated herein by reference.

### FIELD OF TECHNOLOGY

The present disclosure relates to the field of electronic devices and, more specifically, to a data processing method and an electronic device.

### BACKGROUND

To improve user experience, the functions of electronic devices such as mobile phones and tablet computers are becoming more and more abundant. There are electronic devices with deformable display screens, such as electronic devices with foldable screens, electronic devices with stretchable screens, etc. However, at present, there is lack of adaptation design between the deformation of the display screen of the electronic device and the display area of the display screen. More specifically, during the deformation process of the display screen, the user's viewing area generally also changes, but the content display area does not change with the change of the user's viewing area, thus resulting in poor viewing experience for the user.

### SUMMARY

One aspect of the present disclosure provides a data processing method. The data process method includes obtaining a first parameter and determining a target output area based on the first parameter. The first parameter is used to characterize a relative position of a first body of an electronic device and a second body of the electronic device. The deformation of a display screen of the electronic device corresponds to the relative position of the first body and the second body. The target output area is used to display a target object, and the target output area belongs to a display area of the display screen.

Another aspect of the present disclosure provides an electronic device. The electronic device includes an acquisition module and a determining module. The acquisition module is configured to obtain a first parameter. The first parameter is used to characterize a relative position of a first body and a second body of an electronic device. The deformation of a display screen of the electronic device corresponds to the relative position of the first body and the second body. The determining module is configured to determine a target output area based on the first parameter. The target output area is used to display a target object, and the target output area belongs to a display area of the display screen.

### BRIEF DESCRIPTION OF THE DRAWINGS

In the drawings that are not necessarily drawn to scale, same reference numerals may describe similar components in different views. The same reference numerals with letter suffixes or different letter suffixes may indicate different examples of similar components. The drawings generally show various embodiments by way of example rather than limitation, and are used together with the specification and claims to describe the disclosed embodiments. When appropriate, the same reference numerals are used in all drawings to refer to same or similar components. Such embodiments are illustrative, and are not intended to be exhaustive or exclusive embodiments of the present device or method.

FIG. 1 is a flowchart of a data processing method according to an embodiment of the present disclosure.

FIG. 2 is a schematic diagram of an electronic device adopting the data processing method of the embodiments of the present disclosure. The electronic device shown in FIG. 2 is in a buckled state.

FIG. 3 is a schematic diagram of an electronic device adopting the data processing method of the embodiments of the present disclosure, where an angle between a first body and a second body of the electronic device shown in FIG. 3 is 30°.

FIG. 4 is a schematic diagram of an electronic device adopting the data processing method of the embodiments of the present disclosure, where the angle between the first body and the second body of the electronic device shown in FIG. 4 is 120°.

FIG. 5 is a schematic diagram of an electronic device adopting the data processing method of the embodiments of the present disclosure. The electronic device shown in FIG. 5 is in a flattened state.

FIG. 6 is a schematic diagram of a display interface of a display screen of the electronic device adopting the data processing method of the embodiments of the present disclosure. FIG. 6 shows the display interface when the angle between the first body and the second body is 30°.

FIG. 7 is a schematic diagram of the electronic device and the display interface of the electronic device adopting the data processing method of the embodiments of the present disclosure, where the angle between the first body and the second body of the electronic device shown in FIG. 7 is 30°.

FIG. 8 is a schematic diagram of a display interface of a display screen of the electronic device adopting the data processing method of the embodiments of the present disclosure. FIG. 8 shows the display interface when the angle between the first body and the second body is 120°.

FIG. 9 is a schematic diagram of the electronic device and the display interface of the electronic device adopting the data processing method of the embodiments of the present disclosure, where the angle between the first body and the second body of the electronic device shown in FIG. 9 is 120°.

FIG. 10 is a schematic diagram of a display interface of a display screen of the electronic device adopting the data processing method of the embodiments of the present disclosure. FIG. 10 shows the display interface when the electronic device is in the flattened state.

FIG. 11 is a schematic structural diagram of the electronic device according to an embodiment of the present disclosure.

### DETAILED DESCRIPTION

The following describes the present disclosure in detail with reference to the accompanying drawings.

It should be understood that various modifications may be made to the embodiments disclosed herein. Therefore, the following description should not be construed as limiting the scope of the invention, but merely as examples of the embodiments consistent with the present disclosure. Those skilled in the art would envision other modifications within the scope and spirit of the present disclosure.

The accompanying drawings, which are incorporated in and constitute a part of the specification, illustrate embodiments of the present disclosure, and together with the general description of the disclosure given above and the detailed description of the embodiments given below explain the principle of the present disclosure.

These and other features of the present disclosure will become apparent from the following description of preferred forms of the embodiments given as non-limiting examples with reference to the accompanying drawings.

It should also be understood that although the present disclosure has been described with reference to certain specific examples, those skilled in the art can certainly implement many other equivalent forms of the present disclosure, which have the features recited in the claims and hence are located within the scope of this protection limited hereby.

The above and other aspects, features, and advantages of the present disclosure will become more apparent in view of the following detailed description in conjunction with the accompanying drawings.

Hereafter, specific embodiments of the present disclosure will be described with reference to the accompanying drawings. However, the disclosed embodiments are merely examples of the present disclosure, which may be implemented in various manners. Well-known and/or repetitive functions and structures are not described in detail to avoid unnecessary or superfluous details that would obscure the disclosure. Hence, specific structural or functional details disclosed herein are not intended to be limiting, but merely as a basis for the claims and as a representative basis for instructing those skilled in the art to variously employ the present disclosure in any literally appropriate, detailed structure.

The present description may use the phrases such as “in one embodiment”, “in another embodiment”, “in yet another embodiment”, or “in other embodiments”, which can refer to one or more of the same or different embodiments consistent with the present disclosure.

For electronic devices capable of deformation, the shape of the display screen will be impacted or determined by the deformation of the electronic device. Take an electronic device with a foldable screen as an example. In conventional technology, no matter how the foldable screen of the electronic device is deformed, the target output area used to display the target object will not change. For example, when the foldable screen of the electronic device unfolds from 0° to 180°, its target output area is always at the same position. However, when the foldable screen of the electronic device is unfolded to different angles, the user's viewable area or preferred viewing area will change accordingly, and the foldable screen of the electronic device in conventional technology cannot meet the user's viewing needs.

Embodiments of the present disclosure provide a data processing method. The data processing method can be applied to electronic devices, which may include mobile phones, tablet computers (PADs), personal computers (PCs), etc. The specific type of electronic device is not limited in the present disclosure, as long as the electronic device includes a first body 1 and a second body 2 whose relative positions can be changed. For example, for a foldable screen of an electronic device, the first body 1 and the second body 2 may be relatively pivoted, and for a stretchable screen of an electronic device, the distance between the ends of the first body 1 and the second body 2 that are close to the outside may be changed.

More specifically, the electronic device described above may be one of an inner folding screen electronic device, an outer folding screen electronic device, and a stretchable screen electronic device, where the stretchable screen electronic device may also be referred to as a scroll-screen electronic device.

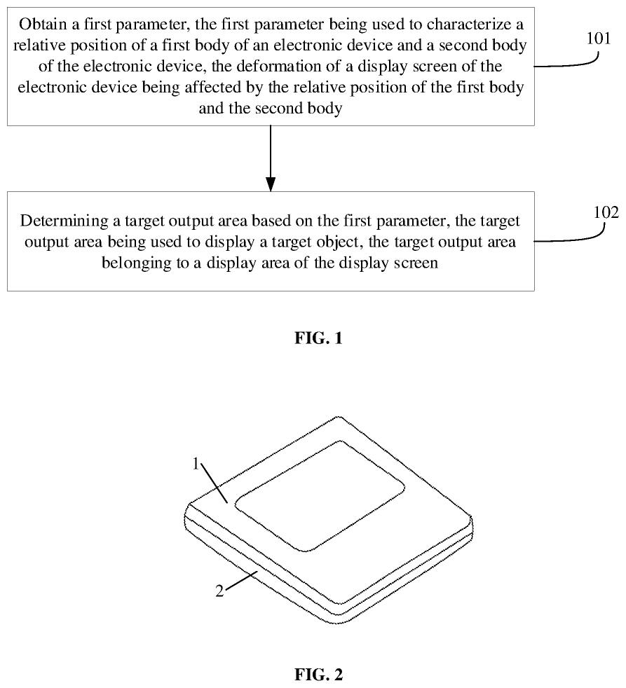

FIG. 1 is a flowchart of a data processing method according to an embodiment of the present disclosure. The method will be described in detail below.

101, obtaining a first parameter, the first parameter being used to characterize the relative position of the first body 1 of the electronic device and the second body 2 of the electronic device. In some embodiments, the deformation of the display screen of the electronic device may be impacted by the relative positions of the first body 1 and the second body 2.

In some embodiments, the first body and the second body may not be the only restrictions on the number of bodies of the electronic device, but may be defined as at least any two bodies or any two body components among a plurality of bodies whose relative positions can be changed in the electronic device. Further, the body assembly may also include a plurality of sub-bodies that can change their relative positions. When the display screen of an electronic device is configured as a deformable display screen, for example, a flexible screen, the display screen may be arranged on at least two bodies, or may be arranged on at least two sub-bodies.

In some embodiments, the display screen may be partially arranged on the first body 1, and partially arranged on the second body 2. As such, the degree of deformation of the display screen of the electronic device can change as the relative position between the first body 1 and the second body 2 changes.

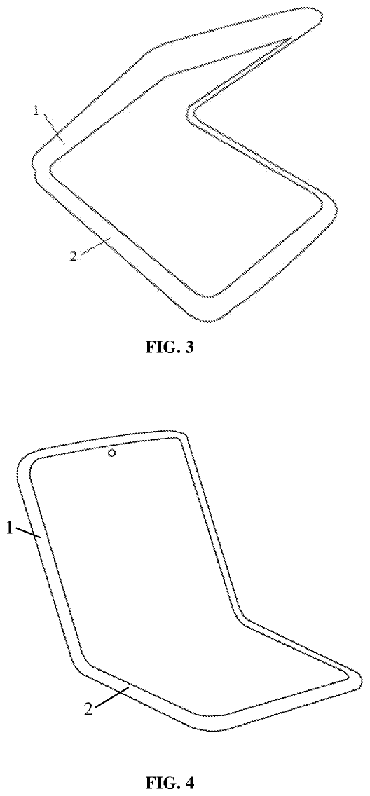

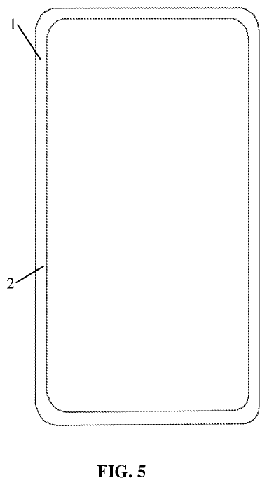

For example, refer to FIG. 2 to FIG. 5. FIG. 2 to FIG. 5 are schematic diagrams of the process of the gradual change of the relative position of the first body 1 and the second body 2 when the electronic device is an electronic device with an inner folding screen. The relative position of the first body 1 and the second body 2 may be reflected by the angle between them. In FIG. 2, the angle between the first body 1 and the second body 2 is 0°. In FIG. 3, the angle between the first body 1 and the second body 2 is 30°. In FIG. 4, the angle between the first body 1 and the second body 2 is 120°. In FIG. 5, the angle between the first body 1 and the second body 2 is 180°. It can be seen that as the angle between the first body 1 and the second body 2 gradually increases, the display screen of the electronic device can be deformed from a buckled state in FIG. 2 to a flattened state in FIG. 5.

In some embodiments, for a folding screen electronic device, the first parameter may be the angle between the first body 1 and the second body 2 of the electronic device, for a stretchable screen electronic device, the first parameter may be the distance between the ends of the first body 1 and the second body 2 that are close to the outside. That is, the first parameter can characterize the relative positional relationship between the first body 1 and the second body 2.

In some embodiments, for a folding screen electronic device, the first parameter may be obtained through a magnetic field sensing device, a gravity sensor, an angle sensor, a gyroscope, and other devices. The present disclosure does not limit the method of obtaining the first parameter, as long as the relative positional relationship between the first body 1 and the second body 2 can be determined through the first parameter.

102, determining a target output area based on the first parameter, the target output area being used to display a target object, the target output area belonging to a display area of the display screen.

In some embodiments, the target output area may be a part of the display area of the display screen, or it may be the entire display area. The target output area may be changed with the change of the first parameter, and the specific change method of the target output area may include: changing the display position of the target output area, the display size of the target output area, etc. The display position of the target output area may be near the bottom, in the center, or near the top of the display area of the display screen. The display size of the target output area may be understood as the display area occupied by the target output area in the display area of the display screen.

The target output area may be changed with the change of the first parameter. More specifically, the first parameter and the target output area may be associated, and the target output area may change with the change of the first parameter based on the association. As such, the data processing method of the present disclosure can use a mapping table capable of reflecting the association relationship between the first parameter and the target output area, and determine the corresponding target output area by calling the mapping table after obtaining the first parameter.

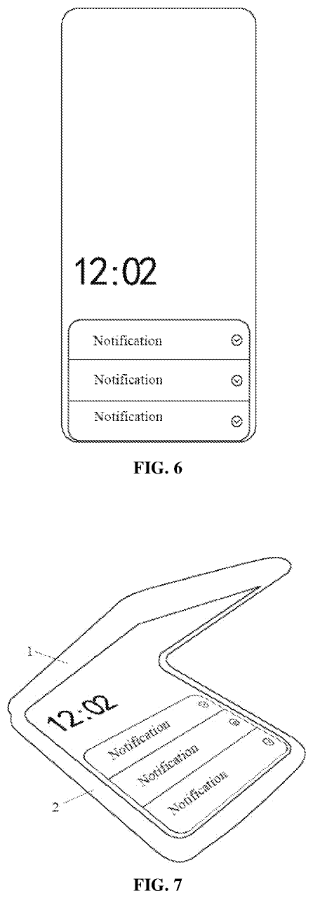

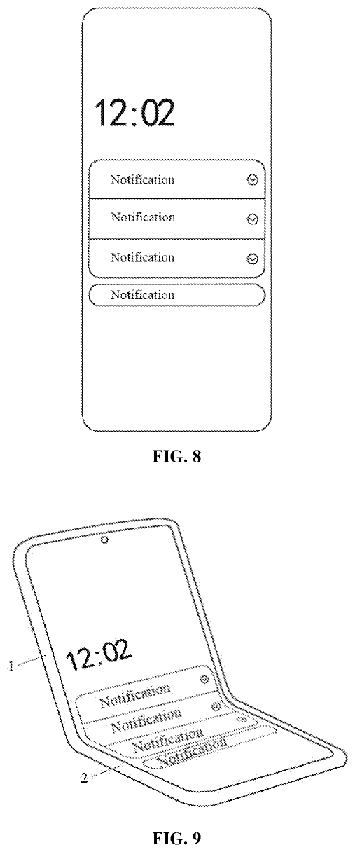

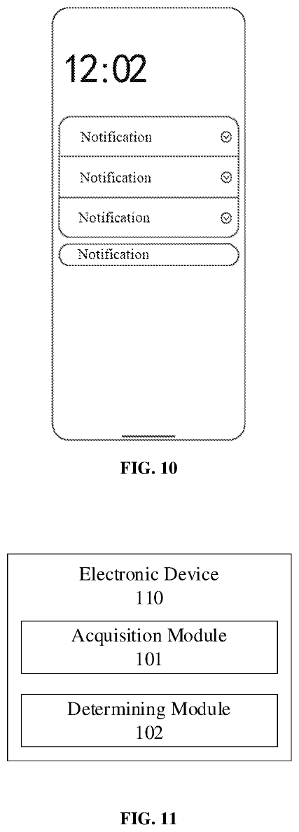

For example, the mapping table may be reflected as follow. Refer to FIG. 3, when the first parameter indicates that the angle between the first body 1 and the second body 2 is 30°, the position of the target output area may be a first position near the bottom of the display screen, as shown in FIG. 6 and FIG. 7. Refer to FIG. 4, when the first parameter indicates that the angle between the first body 1 and the second body 2 is 120°, the position of the target output area may be a second position centered on the display screen, as shown in FIG. 8 and FIG. 9. Refer to FIG. 5, when the first parameter indicates that the angle between the first body 1 and the second body 2 is 180°, the position of the target output area may be a third position near the top of the display screen, as shown in FIG. 10. In some embodiments, the upper and lower positions of the display screen may be defined as follow: taking the vertical attitude of the display screen as a reference, the position close to the lower edge of the display screen may be the lower position, and the position close to the upper edge of the display screen may be the upper position. Similarly, the mapping table may also reflect the relationship between the first parameter and the size of the target output area, which will not be described in detail here.

Consistent with the present disclosure, by obtaining the first parameter that can characterize the relative position of the first body 1 and the second body 2 of the electronic device, the target output area belonging to the display area on the display screen of the electronic device can be determined, thereby realizing the adaptation design between the deformation of the display screen and the target output area on the display screen. Since the user's viewing area on the display screen will change with the deformation of the display screen during the deformation process of the display screen, the embodiments of the present disclosure can adopt the method of determining the target output area based on the first parameter, such that the target output area can match the user's viewing needs.

With the switching of the positional relationship between the first body and the second body, the size of the user's viewable area will also change accordingly. For example, when the unfolding angle between the first body 1 and the second body 2 is at 30°, as shown in FIG. 3, the user can only see a small part of the screen, when the unfolding angle is at 120°, as shown in FIG. 4, the user can see most of the screen. It can be understood that as the unfolding angle changes from 30° to 120°, the size of the user's viewable area increases accordingly. If the unfolding angle is at 30°, the size of the target output area is too large, and the part beyond the user's viewable area cannot be seen by the user; and, when the unfolding angle is at 120°, the size of the target output area is too small, and the limited target output area will cause a waste of the display area compared to the user's viewable area.

Therefore, to address the mismatch between the size of the target output area and the size of the user's viewable area, in some embodiments, the data processing method may further include: if the first parameter indicates that the first body 1 and the second body 2 are in a first positional relationship, the target output area is a first area; the first parameter indicates that the first body 1 and the second body 2 are in a second positional relationship, the target output area is a second area, the first positional relationship being different from the second positional relationship, the second area including the first area.

For example, the first positional relationship may be that the unfolding angle between the first body 1 and the second body 2 is at 30°, the corresponding target output area may be the first area, and the first area may be of a first size; the second positional relationship may be that the unfolding angle between the first body 1 and the second body 2 is at 120°, the corresponding target output area is the second area, and the second area may be of a second size. By setting the size of the second area to be larger than the size of the first area, the size of the target output area can match the size of the user's viewable area.

Since the size of the second area is larger than the size of the first area, the size of the target output area is adjustable, which means that the target output area does not always need to occupy the entire display area (that is, full-screen display), and can only occupy part of the display area (that is, partial display). Compared with the full-screen display in the display area, the partial display can also save energy consumption.

In some embodiments, the determination of the first area and the second area may be done in different ways. For example, when the first parameter indicates that the unfolding angle between the two bodies is at 30°, the first size of the first area may be determined by looking up the association relationship between the first parameter and the size of the target output area. Similarly, when the first parameter indicates that the unfolding angle between the two bodies is at 120°, the second size of the first area may also be determined by looking up the association relationship. If the unfolding angle between the two bodies changes from 30° to 120°, the size of the target output area may also change dynamically, which can be adjusted from the first size to the second size based on the association relationship in the mapping table, or changed to the second size at a predetermined rate of change based on the first size. Of course, there may be other ways to determine the size of the target output area, which is not limited by the embodiments of the present disclosure.

With the switching of the positional relationship between the first body and the second body, the user's viewing position on the display screen may also change accordingly. For example, when the unfolding angle between the first body 1 and the second body 2 is at 30°, as shown in FIG. 3, the user's viewing position is in the lower half of the display screen, when the unfolding angle between the first body 1 and the second body 2 is at 120°, as shown in FIG. 4, the user's viewing position is in the center of the display screen. It can be understood that as the unfolding angle changes from 30° to 120°, the user's viewing position moves up accordingly. When the unfolding angle is at 30° and the target output area is in the upper half of the display screen, the target output area will not be visible to the user; if the unfolding angle is at 120° and the target output area is in the lower half of the display screen, it will not match the user's viewing habits.

Therefore, to address the mismatch between the position of the target output area and the user's viewing position, in some embodiments, if the first parameter indicates that the first body 1 and the second body 2 are in the first positional relationship, the target output area may be located at a first position; if the first parameter indicates that the first body 1 and the second body 2 are in the second positional relationship, the target output area may be located at a second position, the first positional relationship being different from the second positional relationship, the first position being different from the second position.

For example, the first positional relationship may be that the unfolding angle between the first body 1 and the second body 2 is at 30°, and the corresponding target output area is located at the first position. As shown in FIG. 6, the first position is at the bottom of the display screen. The second positional relationship may be that the unfolding angle between the first body 1 and the second body 2 is at 120, and the corresponding target output area is located at the second position. As shown in FIG. 8, the second position is in the center of the display screen. By setting the position of the target output area at different first and second positions, the position of the target output area can be matched to the user's viewing position.

In some embodiments, the first position or the second position may be determined differently. For example, when the first parameter indicates that the unfolding angle between the two bodies is at 30°, the first position may be determined by looking up the association relationship between the first parameter and the position of the target output area. Similarly, when the first parameter indicates that the unfolding angle between the two bodies is at 120°, the second position may also be determined by looking up the association relationship. If the unfolding angle between the two bodies changes from 30° to 120°, the position of the target output area may also change dynamically. The position of the target output area may be adjusted from the first position to the second position based on the association relationship in the mapping table, or it can be changed to the second position at a predetermined rate of change based on the first position. Of course, there may be other ways to determine the position of the target output area, which is not limited in the embodiments of the present disclosure.

Based on the foregoing embodiments, the size and position of the target output area may be changed. Changing the size and position of the target output area may include controlling a target display unit corresponding to the target output area to be in an operating state based on the target output area to display the target object, the display area of the display screen including a plurality of display units, and the target display unit being a part of the plurality of display units.

In some embodiments, the display screen may be an OLED display screen, and the display screen may include a plurality of pixel units. The pixel units may be understood as the display units described above. After determining the target output area, its corresponding target display units may be determined, and the target display units may be switched to the operating state, thereby achieving the effect that the target display units corresponding to the target output area can operate to display the target object.

In some embodiments, when determining the target display units corresponding to the target output area, the target display units may be in the operating state or in a non-operating state. If the target display units are in the operating state, the target display units may maintain the operating state. If the target display units are in the non-operating state, the state of the target display units may need to be switched from the non-operating state to the operating state. As such, by switching the state of the target display units to the operating state, the target display units corresponding to the target output area can work to present the target content.

Further, after the target display units are determined, the state of other non-target display units included in the display screen may be switched to the non-operating state. That is, if the non-target display units are in the operating state, the state of the non-target display units may be switched from the operating state to the non-operating state; and, if the non-target display units are in the non-operating state, the non-target display units may maintain the non-operating state. As such, by controlling the state of the target display units and the non-target display units, only the target output area in the display area on the display screen can present content. Since some display units can be controlled not to work, energy consumption can be reduced.

In some embodiments, the data processing method may further include: obtaining a second parameter, the second parameter being different from the first parameter.

After obtaining the first parameter, the second parameter may be further obtained, and the target output area may be determined based on these two types of parameters, which can further match the user's viewing needs. A specific embodiment will be described below.

In some embodiments, the second parameter may also be a parameter characterizing the attitude of the electronic device, the attitude of the electronic device including a landscape attitude, a portrait attitude, etc. In addition, the second parameter may also be a parameter that characterizes the relative position change speed of the first body and the second body. For example, the second parameter may be the movement speed of the first body 1 or the second body 2, or the relative movement speed of the two bodies, or the relative movement acceleration of the two bodies, etc. In some embodiments, the speed or acceleration may be instantaneous or average.

The attitude of the electronic device may include a landscape attitude and a portrait attitude. As the attitude of the electronic device changes, the user's viewing area generally also changes. For example, when the unfolding angle between the first body and the second body is at 30°, if the electronic device is in a landscape attitude, the user's viewing position is generally at the center of the display screen. When the unfolding angle between the first body and the second body is at 30°, if the electronic device is in a portrait attitude, as shown in FIG. 3, the user's viewing position is generally at the lower position of the display screen. Therefore, in order to match the change of the user's viewing position, the position of the target output area needs to be determined in combination with the attitude of the electronic device. Similarly, in order to match the change in the size of the user's viewing area, the size of the target output area needs to be determined in combination with the attitude of the electronic device.

In order to meet this usage requirement, in some embodiments, determining the target output area based on the first parameter may include determining the target output area based on the first parameter and the second parameter, the target output area being at least a partial area of the display area of the display screen.

In some embodiments, if the first parameter indicates that the first body 1 and the second body 2 are in the first positional relationship and the second parameter indicates that the attitude of the electronic device relative to the reference plane is a first attitude, the target output area may be the first area; if the first parameter indicates that the first body 1 and the second body 2 are in the first positional relationship and the second parameter indicates that the attitude of the electronic device relative to the reference plane is a second attitude, the target output area may be the second area. In some embodiments, the first area may be different from the second area. More specifically, the positions of the first area and the second area may be different, or the sizes of the first area and the second area may be different.

More specifically, the first attitude and the second attitude may use the horizontal plane as the reference plane. The first attitude can be understood as the display screen of the electronic device being a portrait attitude relative to the horizontal plane; the second attitude can be understood as the display screen of the electronic device being in a landscape attitude relative to the horizontal plane. As shown in FIG. 3 and FIG. 5, the electronic device is in a portrait state.

As such, when the relative position between the first body 1 and the second body 2 is the same, the target output area on the display screen can be controlled to be located at different positions based on the difference in the attitude of the electronic device relative to the reference plane determined by the second parameter, thereby realizing the dynamic adjustment of the target output area based on the attitude of the electronic device. Further, the target output area is not only related to the relative positional relationship between the first body 1 and the second body 2, but also related to the attitude of the electronic device, thereby adapting to the size of the user's viewing area or the user's viewing position.

For example, when the unfolding angle between the first body 1 and the second body 2 is at 30°, and the electronic device is in the portrait attitude, the first area may be the lower area of the electronic device in the portrait attitude; and, when the angle between the first body 1 and the second body 2 is at 30°, and the electronic device is in the landscape attitude, the first area may be the center area of the electronic device in the landscape attitude. Similarly, when the electronic device is in the portrait attitude or the landscape attitude, the sizes of the first area and the second area may also be set to be different, which will not be described in detail here.

In some embodiments, if the second parameter satisfies a target condition, determining the target output area based on the first parameter may be performed, the target output area being a partial area of the display area of the display screen. If the second parameter does not satisfy the target condition, the entire display area of the display screen may be used as the target output area, that is, a full-screen display. In this embodiment, whether to enable the partial display mode or the full-screen display mode can be determined by determining whether the second parameter satisfies the target condition.

It is conceivable that, compared with the full-screen display mode, the partial display mode can achieve the purpose of reducing energy consumption.

When the user wants to view private information, in order to display the content of the private information in a smaller viewing area, there is a need to enable the partial display mode. At the same time, the user's usage habits generally include: adjusting the unfolding angle between the first body and the second body at a relatively small angle and maintaining the angle for a period of time, or slowly adjusting the unfolding angle between the first body and the second body to a relatively small angle.

Based on this, in some embodiments, the target condition may be a duration threshold. The second parameter may be used to characterize one of the duration of the first body 1 and the second body 2 of the electronic device being in the first positional relationship, the duration of switching of the first body 1 and the second body 2 of the electronic device from the second positional relationship to the first positional relationship, and the duration of switching of the first body 1 and the second body 2 of the electronic device from a third positional relationship to the first positional relationship.

Take the case where the second parameter is used to characterize the duration of the first body 1 and the second body 2 of the electronic device being in the first positional relationship as an example. Assume that the first positional relationship refers to the unfolding angle between the two bodies being at 30° and the duration threshold is set to 4 seconds. When the unfolding angle between the first body 1 and the second body 2 is at 30° and the duration of maintaining the unfolding angle at 30° reaches 5 seconds, the duration threshold is satisfied. At this time, it can be determined that the second parameter meets the target condition, and the partial display mode can be turned on.

Take the case where the second parameter is used to characterize the duration of switching of the first body 1 and the second body 2 of the electronic device from the second positional relationship to the first positional relationship as an example. Assume that the first positional relationship refers to the unfolding angle between the two bodies being at 30°, the second positional relationship refers to the unfolding angle between the two bodies being at 120°, and the duration threshold is set to 4 seconds. When the angle between the first body 1 and the second body 2 is adjusted from 120° to 30° for 5 seconds, the duration threshold is satisfied. At this time, it can be determined that the second parameter meets the target condition, and the partial display mode can be turned on.

Take the case where the second parameter is used to characterize the duration of switching of the first body 1 and the second body 2 of the electronic device from the third positional relationship to the first positional relationship as an example. Assume that the first positional relationship refers to the unfolding angle between the two bodies being at 30°, the third positional relationship refers to the unfolding angle between the two bodies being at 20°, and the duration threshold is set to 4 seconds. When the angle between the first body 1 and the second body 2 is adjusted from 20° to 30° for 5 seconds, the duration threshold is satisfied. At this time, it can be determined that the second parameter meets the target condition, and the partial display mode can be turned on.

In this embodiment, the intention of the user's usage habits is taken into consideration, and whether to enable the partial display mode can be determined based on the duration of the user's action to satisfy the user's need for enabling the partial display mode.

Similarly, when the user needs to turn on the partial display mode, if the user's usage habit is to slowly adjust the unfolding angle between the first body and the second body to a certain angle, in some embodiments, the target condition may also be a speed threshold. In some embodiments, the second parameter may also be used to characterize one of: the speed at which the first body 1 and the second body 2 of the electronic device switch from the second positional relationship to the first positional relationship; and, the speed at which the first body 1 and the second body 2 of the electronic device switch from the third positional relationship to the first positional relationship.

Take the case where the second parameter is used to characterize the speed at which the first body 1 and the second body 2 of the electronic device switch from the second positional relationship to the first positional relationship as an example. Assume that the first positional relationship refers to the unfolding angle between the two bodies being at 30°, and the second positional relationship refers to the unfolding angle between the two bodies being at 120°. When the speed at which the unfolding angle between the first body 1 and the second body 2 is switched from 120° to 30° is less than the speed threshold, the target condition is considered as satisfied by the second parameter, and the partial display mode can be turned on, otherwise, the full-screen display mode can be turned on.

Take the case where the second parameter is used to characterize the speed at which the first body 1 and the second body 2 of the electronic device switch from the third positional relationship to the first positional relationship as an example. Assume that the first positional relationship refers to the unfolding angle between the two bodies being at 30°, and the third positional relationship refers to the unfolding angle between the two bodies being at 20°. When the speed at which the unfolding angle between the first body 1 and the second body 2 is switched from 20° to 30° is less than the speed threshold, the target condition is considered as satisfied by the second parameter, and the partial display mode can be turned on, otherwise, the full-screen display mode can be turned on.

In this embodiment, the intention of the user's usage habits is taken into consideration, and whether to enable the partial display mode can be determined based on the user's movement speed to satisfy the user's need for enabling the partial display mode.

When the user wants to view private information, the user's usage habit generally includes adjusting the unfolding angle between the first body and the second body to a relatively small angle.

Based on this usage habit, in some embodiments, a method to enable the privacy mode can also be provided. More specifically, if the first parameter indicates that the first body 1 and the second body 2 are in the first positional relationship, the target object may be determined from a display object set based on the first parameter, and determining the target output area based on the first parameter may be performed. In some embodiments, the privacy level of the target object may be higher than the privacy level of the display objects other than the target object in the display object set.

Assume that the first positional relationship refers to the unfolding angle between the two bodies being at 30°. When the unfolding angle between the first body 1 and the second body 2 is at 30°, the privacy mode may be turned on, and information with a higher level of privacy can be displayed for the user to match the viewing needs of the user who wants to view private information.

In some embodiments, the position of the target output area may be determined by dynamically collecting the user's eye information. For example, the position where the user's sight falls on the screen can be dynamically collected, and the position of the target output area can be set at this position.

In some embodiments, the privacy level of each target object in the display object set may be set by the user, or it may be set based on the user's operating habits, attention level, etc., which is not limited in the embodiments of the present disclosure.

In some embodiments, the data processing method may use a mapping table that can reflect the association relationship between the first parameter and the privacy mode. After the first parameter is obtained, the mapping table may be called to determine whether the privacy mode needs to be turned on.

In this embodiment, the intention of the user's usage habits is taken into consideration, and whether to enable the privacy mode can be determined based on the unfolding angle of the electronic device to satisfy the user's need for enabling the privacy mode.

In some embodiments, when the electronic device includes an inner folding screen and the unfolding angle between the first body and the second body is an acute angle, if the electronic device is in a portrait attitude, the user's viewing position may be generally on the lower second body, and if the electronic device is in a landscape attitude, the user's viewing position may be generally on the right side of the second body.

Therefore, in some embodiments, the first body 1 and the second body 2 may be in the first positional relationship such that the display screen is bent to form a first display area and a second display area. The first positional relationship can be referred to that the unfolding angle between the two bodies is at an acute angle, and the orthographic projection area of the first body 1 is part of the second display area. As such, by corresponding the target output area of the electronic device to at least part of the second display area, the position of the target output area can be matched to the user's viewing position.

More specifically, the first display area may be formed on the first body 1, and the second display area may be formed on the second body 2. In this case, if the electronic device is in a portrait attitude, the target output area may be on the lower part of the second display area, and if the electronic device is in a landscape attitude, the target output area may be on the right side of the second display area. In the embodiments of the present disclosure, the lower part and the right side of the display area are only examples based on the user's usage habits, and the target output area can also be on the upper part or the left side of the display area, which is not limited in the embodiments of the present disclosure.

For example, for the inner folding screen in the portrait attitude, as shown in FIG. 3 and FIG. 7, when the unfolding angle between the first body 1 and the second body 2 is an acute angle shown in FIG. 3, the target output area is located on the second display area on the second body 2 in FIG. 7.

For an inner folding screen electronic device, in some embodiments, if the first parameter indicates that the first body 1 and the second body 2 are in the first positional relationship, the execution of determining the target output area based on the first parameter and controlling the target output area to move from the second display area to the first display area until the first parameter indicates that the first body 1 and the second body 2 are in the second positional relationship may be stopped. The first body 1 and the second body 2 may be in the second positional relationship such that the display screen is flattened. In some embodiments, the part of the first display area and the part of the second display area may be located in the same plane.

More specifically, the first positional relationship may be that the unfolding angle between the two bodies is an acute angle, and the second positional relationship may be that the unfolding angle between the two bodies is at 180°. Take the portrait attitude as an example (as shown in FIG. 3 to FIG. 5), when the electronic device is switched from the first positional relationship to the second positional relationship (as shown in FIG. 7, FIG. 9, and FIG. 10), the target output area moves from the second display area to the first display area.

When the unfolding angle of the first body 1 and the second body 2 gradually changes from 30° to 180°, based on the user's viewing habit, the viewing position will gradually move up. In this embodiment, in the process of switching the first body 1 and the second body 2 from the first positional relationship to the second positional relationship, the target output area can gradually move with the change of the positional relationship between the bodies to match the change of the user's viewing position.

The target output area may move from the second display area to the first display area in the following two manners. In the first manner, the association relationship between the target output area and the first parameter may be looked up in the mapping table. When the two bodies are in different positional relationships, the position of the corresponding target output area can be respectively looked up, and the position of the target output area may change with the positional relationship between the bodies. In the second manner, the target output area may move from the second display area to the first display area at a preset position movement rate.

In the case where the electronic device is an electronic device with an inner folding screen, the first body 1 and the second body 2 may be hinged by a hinge member. The display area of the display screen corresponding to the hinge member may be uneven, therefore, when the electronic device is flattened, the first display area and/or the second display area may have some uneven areas at the position of the hinge member, but at least other display areas not at the position of the hinge member can be in the same plane.

For an inner folding screen electronic device, in some embodiments, if the first parameter indicates that the first body 1 and the second body 2 are in the first positional relationship, the execution of determining the target output area based on the first parameter and controlling the size of the target output area to expand from the second display area to the first display area until the first parameter indicates that the first body 1 and the second body 2 are in the second positional relationship may be stopped. The first body 1 and the second body 2 may be in the second positional relationship such that the display screen is flattened. In some embodiments, the part of the first display area and the part of the second display area may be located in the same plane.

More specifically, the first positional relationship may be that the unfolding angle between the two bodies is an acute angle, and the second positional relationship may be that the unfolding angle between the two bodies is at 180°. The size of the target output area may be dynamically expanded by gradually moving the upper edge of the target output area upward.

When the unfolding angle of the first body 1 and the second body 2 gradually changes from 30° to 180°, the size of the user's viewing area will gradually increase. In this embodiment, in the process of switching the first body 1 and the second body 2 from the first positional relationship to the second positional relationship, the size of the target output area can gradually expand with the change of the positional relationship between the bodies to match the change of the user's viewing needs.

The target output area may be expanded from the second display area to the first display area in the following two manners. In the first manner, the association relationship between the target output area and the first parameter may be looked up in the mapping table. When the two bodies are in different positional relationships, the size of the corresponding target output area may be looked up, and the size of the target output area may change with the change of the positional relationship between the bodies. In the second manner, the upper edge of the target output area may move from the second display area to the first display area at a preset moving rate.

In some embodiments, the number of target objects may be related to the size of the target output area, and the number of target objects may increase as the size of the target output area increases.

For example, refer to FIG. 7 and FIG. 9. FIG. 7 shows the target objects in the target output area when the unfolding angle between the first body 1 and the second body 2 is at 30°. Three notifications are shown in FIG. 7, that is, there are three target objects. FIG. 9 shows the target objects in the target output area when the unfolding angle between the first body 1 and the second body 2 is at 120°. Four notifications are shown in FIG. 9, that is, there are four target objects. It can be seen that as the unfolding angle between the first body 1 and the second body 2 increases, the size of the target output area increases, and the number of target objects also increases accordingly.

An embodiment of the present disclosure also provides an electronic device 110. As shown in FIG. 11, electronic device 110 includes an acquisition module 101 and a determining module 102. The acquisition module 101 may be configured to obtain a first parameter, the first parameter being used to characterize the relative position of the first body 1 of the electronic device 110 and the second body 2 of the electronic device 110. In some embodiments, the deformation of the display screen of the electronic device 110 may be impacted by the relative position of the first body 1 and the second body 2. The determining module 102 may be configured to determine a target output area based on the first parameter, the target output area being used to display a target object. In some embodiments, the target output area may belong to a display area of the display screen.

In some embodiments, the electronic device 110 may also include a processing module. The processing module may be configured to determine that the target output area is a first area if the first parameter indicates that the first body 1 and the second body 2 are in a first positional relationship; determine that the target output area is a second area the first parameter indicates that the first body 1 and the second body 2 are in a second positional relationship, the first positional relationship being different from the second positional relationship, the second area including the first area.

In some embodiments, the processing module may be further configured to determine that the target output area may be located at a first position if the first parameter indicates that the first body 1 and the second body 2 are in the first positional relationship; determine that the target output area may be located at a second position if the first parameter indicates that the first body 1 and the second body 2 are in the second positional relationship, the first positional relationship being different from the second positional relationship, the first position being different from the second position.

In some embodiments, the processing module may be further configured to control a target display unit corresponding to the target output area to be in an operating state based on the target output area to display the target object, the display area of the display screen including a plurality of display units, and the target display unit being a part of the plurality of display units.

In some embodiments, the acquisition module 101 may be further configured to obtain a second parameter, the second parameter being different from the first parameter.

In some embodiments, the processing module may be further configured to determine the target output area based on the first parameter and the second parameter, the target output area being a partial area of the display area of the display screen. In some embodiments, if the first parameter indicates that the first body 1 and the second body 2 are in the first positional relationship and the second parameter indicates that the attitude of the electronic device 110 relative to the reference plane is a first attitude, the target output area may be the first area; if the first parameter indicates that the first body 1 and the second body 2 are in the first positional relationship and the second parameter indicates that the attitude of the electronic device 110 relative to the reference plane is a second attitude, the target output area may be the second area. In some embodiments, the first area may be different from the second area.

In some embodiments, the processing module may be further configured to perform the processing of determining the target output area based on the first parameter if the second parameter satisfies a target condition, the target output area being a partial area of the display area of the display screen.

In some embodiments, the target condition may be a duration threshold. The second parameter may be used to characterize one of: the duration of the first body 1 and the second body 2 of the electronic device 110 being in the first positional relationship, the duration of switching of the first body 1 and the second body 2 of the electronic device 110 from the second positional relationship to the first positional relationship, and the duration of switching of the first body 1 and the second body 2 of the electronic device 110 from a third positional relationship to the first positional relationship.

In some embodiments, the target condition may be a speed threshold. The second parameter may be used to characterize one of: the speed at which the first body 1 and the second body 2 of the electronic device 110 switch from the second positional relationship to the first positional relationship; and, the speed at which the first body 1 and the second body 2 of the electronic device 110 switch from the third positional relationship to the first positional relationship.

In some embodiments, the processing module may be further configured to, if the first parameter indicates that the first body 1 and the second body 2 are in the first positional relationship, determine the target object from a display object set based on the first parameter, and perform the process of determining the target output area based on the first parameter. In some embodiments, the privacy level of the target object may be higher than the privacy level of the display objects other than the target object in the display object set.

In some embodiments, the target output area may correspond to the first body 1 and the second body 2 being in a first positional relationship. The target output area may correspond to at least part of a second display area. When the first body and the second body are in the first positional relationship, the display screen is bent to form a first display area and the second display area.

In some embodiments, the processing module may be further configured to, if the first parameter indicates that the first body 1 and the second body 2 are in the first positional relationship, the processes of determining the target output area based on the first parameter and controlling the target output area to move from the second display area to the first display area until the first parameter indicates that the first body 1 and the second body 2 are in the second positional relationship may be stopped. The first body 1 and the second body 2 may be in the second positional relationship such that the display screen is flattened. In some embodiments, the part of the first display area and the part of the second display area may be located in the same plane.

In some embodiments, the processing module may be further configured to, if the first parameter indicates that the first body 1 and the second body 2 are in the first positional relationship, the processes of determining the target output area based on the first parameter and controlling the size of the target output area to expand from the second display area to the first display area until the first parameter indicates that the first body 1 and the second body 2 are in the second positional relationship may be stopped. The first body 1 and the second body 2 may be in the second positional relationship such that the display screen is flattened. In some embodiments, the part of the first display area and the part of the second display area may be located in the same plane.

In some embodiments, the number of target objects may be related to the size of the target output area.

It should be noted that modules of the system of the present disclosure are logically divided according to their functions. These modules are provided for the purposes of illustration, and not intended to limit the scope of the present disclosure. These modules may be re-divided or combined according to different requirements. For example, some modules may be combined into a single module, or further divided into more sub-modules.

Various modules of the present disclosure may be implemented by hardware, software running in one or more processors, or a combination of them. For persons having ordinary skills in the art, some or all of the functions of the modules of the present disclosure may be implemented by a microprocessor or a digital signal processor (DSP). The present disclosure may also be implemented as a device or a program running in a device (e.g., a computer program and a product with computer programs) that perform a part of, or all of the methods described herein. Such programs may be stored on a computer readable medium, or may be in a form of one or more signals. Such signals may be downloaded from an Internet website, provided on a carrier signal, or provided in any other forms. In addition, the present invention can be implemented by means of a device comprising a plurality of different components. In a claim in which a plurality of components are listed, the plurality of such components can be embodied by the same component item. The use of the terms “first”, “second”, “third” and the like does not represent any order. Such terms can be interpreted as names.

In addition, although exemplary embodiments have been described herein, the scope includes any and all implementations with equivalent elements, modifications, omissions, combinations (for example, cross-over arrangements of various embodiments), adaptations, or changes based on the present disclosure. Elements in the claims are interpreted broadly based on the language adopted in the claims, and are not limited to the examples described in this specification or during the implementation of the present disclosure, and the examples are interpreted as non-exclusive. Therefore, the present disclosure and examples are intended to be regarded as examples only, and the true scope and spirit are indicated by the following claims and the full scope of their equivalents.

The above description is intended to be illustrative and not restrictive. For example, the above examples (or one or more of them) can be used in combination with each other. For example, a person of ordinary skill in the art may use other embodiments when reading the forgoing description. In addition, in the foregoing specific embodiments, various features may be grouped together to simplify the present disclosure. This should not be interpreted as an intent that a disclosed feature that is not claimed is necessary for any claim. On the contrary, the subject matter of the present disclosure may be less than all the features of a specific disclosed embodiment. Thus, the following claims are incorporated into the detailed description as examples or embodiments, wherein each claim independently serves as a separate embodiment, and it is considered that these embodiments can be combined with each other in various combinations or permutations. The scope of the present disclosure should be determined with reference to the appended claims and the full scope of equivalents entitled by these claims.

The above embodiments are only exemplary embodiments of the present disclosure, and are not used to limit the present disclosure, and the protection scope of the present disclosure is defined by the claims. Those skilled in the art can make various modifications or equivalent substitutions to the present disclosure within the essence and protection scope of the present disclosure, and such modifications or equivalent substitutions should also be regarded as falling within the protection scope of the present disclosure.

What is claimed is:

1. A data processing method comprising:
obtaining a first parameter, the first parameter characterizing a relative position of a first body of an electronic device and a second body of the electronic device, a deformation of a display screen of the electronic device being corresponding to the relative position of the first body and the second body; and
determining a target output area based on the first parameter, the target output area displaying a target object, wherein:
the target output area belongs to a display area of the display screen.

2. The data processing method of claim 1, wherein:
if the first parameter indicates that the first body and the second body are in a first positional relationship, the target output area is a first area; and
if the first parameter indicates that the first body and the second body are in a second positional relationship, the target output area is a second area, the first positional relationship being different from the second positional relationship, the second area including the first area.

3. The data processing method of claim 1, wherein:
if the first parameter indicates that the first body and the second body are in a first positional relationship, the target output area is located at a first position; and
if the first parameter indicates that the first body and the second body are in a second positional relationship, the target output area is located at a second position, the first positional relationship being different from the second positional relationship, the first position being different from the second position.

4. The data processing method of claim 1 further comprising:
controlling a target display unit corresponding to the target output area to be in an operating state based on the target output area to display the target object, the display area of the display screen including a plurality of display units, the target display unit being a part of the plurality of display units.

5. The data processing method of claim 1 further comprising:
obtaining a second parameter, the second parameter being different from the first parameter.

6. The data processing method of claim 5, wherein determining the target output area based on the first parameter includes:
determining the target output area based on the first parameter and the second parameter, the target output area being at least a partial area of the display area of the display screen, wherein:
if the first parameter indicates that the first body and the second body are in a first positional relationship and the second parameter indicates that the electronic device is at a first attitude relative to a reference plane, the target output area is a first area; and
if the first parameter indicates that the first body and the second body are in a first positional relationship and the second parameter indicates that the electronic device is at a second attitude relative to the reference plane, the target output area is a second area.

7. The data processing method of claim 5, wherein:
if the second parameter satisfies a target condition, determine the target output area based on the first parameter, the target output area being the partial area of the display area of the display screen.

8. The data processing method of claim 7, wherein:
the target condition is a duration threshold; and
the second parameter characterizes one of a duration during which the first body and the second body of the electronic device are in a first positional relationship;
a duration during which the first body and the second body of the electronic device switch from a second positional relationship to a first positional relationship; and
a duration during which the first body and the second body of the electronic device switch from a third positional relationship to the first positional relationship.

9. The data processing method of claim 7, wherein:
the target condition is a speed threshold; and
the second parameter characterizes one of the speed at which the first body and the second body of the electronic device switch from a second positional relationship to a first positional relationship; and
the speed at which the first body and the second body of the electronic device switch from a third positional relationship to the first positional relationship.

10. The data processing method of claim 1 further comprising:
determining the target object from a display object set based on the first parameter and determining the target output area based on the first parameter if the first parameter indicates that the first body and the second body are in the a positional relationship, privacy level of the target object being higher than the privacy level of the display objects other than the target object in the display object set.

11. The data processing method of claim 1, wherein:
the target output area corresponds to at least part of a second display area, the first body and the second body being in a first positional relationship such that the display screen is bent to form a first display area and the second display area.

12. The data processing method of claim 11, wherein:
if the first parameter indicates that the first body and the second body are in the first positional relationship, determining the target output area based on the first parameter and moving the target output area from the second display area to the first display area until the first parameter indicates that the first body and the second body are in a second positional relationship, the first body and the second body being in the second positional relationship such that the display screen is flattened, part of the first display area and the part of the second display area being located in the same plane.

13. The data processing method of claim 11, wherein:
if the first parameter indicates that the first body and the second body are in the first positional relationship, determining the target output area based on the first parameter and expanding the target output area from the second display area to the first display area until the first parameter indicates that the first body and the second body are in a second positional relationship, the first body and the second body being in the second positional relationship such that the display screen is flattened, part of the first display area and part of the second display area being located in the same plane.

14. The data processing method of claim 13, wherein:
the number of target objects is related to the size of the target output area.

15. An electronic device comprising:
an acquisition module, the acquisition module being configured to obtain a first parameter, the first parameter characterizing a relative position of a first body and a second body of an electronic device, a deformation of a display screen of the electronic device being corresponding to the relative position of the first body and the second body; and
a determining module, the determining module being configured to determine a target output area based on the first parameter, the target output area displaying a target object, wherein:
the target output area belongs to a display area of the display screen.

16. The electronic device of claim 15, wherein:
if the first parameter indicates that the first body and the second body are in a first positional relationship, the target output area is a first area;
if the first parameter indicates that the first body and the second body are in a second positional relationship, the target output area is a second area, the first positional relationship being different from the second positional relationship, the second area including the first area.

17. The electronic device of claim 15, wherein:
if the first parameter indicates that the first body and the second body are in a first positional relationship, the target output area is located at a first position; and
if the first parameter indicates that the first body and the second body are in a second positional relationship, the target output area is located at a second position, the first positional relationship being different from the second positional relationship, the first position being different from the second position.

18. The electronic device of claim 15 further comprising:
a processing module, the processing module being configured to control a target display unit corresponding to the target output area to be in an operating state based on the target output area to display the target object, the display area of the display screen including a plurality of display units, the target display unit being a part of the plurality of display units.

19. The electronic device of claim 15, wherein the acquisition module is further configured to:
obtain a second parameter, the second parameter being different from the first parameter.

20. A non-transitory computer-readable storage medium storing a computer instruction that, when executed by a processor, causes the processor to:
obtain a first parameter, the first parameter characterizing a relative position of a first body of an electronic device and a second body of the electronic device, a deformation of a display screen of the electronic device being corresponding to the relative position of the first body and the second body; and
determine a target output area based on the first parameter, the target output area displaying a target object, wherein the target output area belongs to a display area of the display screen.
